(19) United States
(12) Patent Application Publication
(10) Pub. No.: US 2020/0211012 A1
(43) Pub. Date: Jul. 2, 2020

(54) ELECTRONIC FRAMEWORK AND NETWORKED SYSTEM FOR VARIABLE CLASS DESIGNATIONS AND POLICIES

(71) Applicant: Brex, Inc., San Francisco, CA (US)

(72) Inventors: Pedro Franceschi, San Francisco, CA (US); Ignacio Corderi, San Francisco, CA (US); Henrique Dubugras, San Francisco, CA (US)

(21) Appl. No.: 16/238,498

(22) Filed: Jan. 2, 2019

(51) Int. Cl. G06Q 20/40; G06F 9/54

(52) U.S. Cl. CPC G06Q 20/405; G06F 9/542

(57) ABSTRACT

There are provided systems and methods for an electronic framework and networked system variable class designations and policies. An expense management service may be provided by a networked service provider, where the service provider's system may be integrated into a payment network so that the service provider may provide expense policy management for organizations. The service provider may establish user groups and expense policies, and associations between the two for the organization, as well as allow the organization to designate payment networks. The service provider may then exchange bank and accounting data with an organization, onboard the organization's employees, and receive payment network data between acquiring and issuing banks to control authorizations and expense managements with the issuing bank. The service provider may then approve or deny transaction based on variable class designations and expense policies.

### TECHNICAL FIELD

The present application generally relates to expense management through a networked control system and more specifically to a control framework and network system that allows organizations to designate variable user classes and expense policies that control authorizations with issuers associated with payment networks.

### BACKGROUND

Organizations, such as businesses and companies, require expense management software, hardware, and other infrastructure to manage expenses and control user transactions. This includes issues with establishing and issuing payment instruments, tracking expenses and other accounting requirements, enforcing expense policies, and collecting auditing information. However, present networked systems and available company infrastructure merely provide for a few specific gatekeepers who are manually required to review and approve payments. These accounting teams or company officers are then required to personally review expenses and approve or deny them. This is taxing for all types of companies, such as at small companies, where only a select few may have access to company payment instruments to allow company purchasing, and at large companies, where large numbers of employees may be submitting transaction requests from all over the world. However, by issuing additional payment instruments, the company becomes more at risk for fraud.

General expense policies and limits may be placed on payment instruments issued to company employees, but present systems require submission of reimbursement requests, which is taxing on users of the system and lead to employees abusing the system to come below policy limits or fit purchases into non-compliant categories. Moreover, this solution occurs after the fact of payment, meaning employees may be personally liable if a purchase does not fit within a category. The present systems do not prevent unauthorized purchases or require an approval from a company manager or official, and their integration into electronic communication and payment systems is incompatible. Those systems that impose static limits on payment instruments before payment do not allow for criteria other than payment amount to be considered, and when the user's role or authorizations change, the imposed limits need to be manually changed by an administrator with authority over the card. Thus, these present systems fail to identify users and company attributes, establish an electronic framework to control expenses based on the users and their attributes, integrate multiple payment networks into the framework, and manage transaction processing based on the framework and integrated payment networks.

Therefore, there is a need to address deficiencies with conventional systems used by companies to better manage employee spending.

### BRIEF DESCRIPTION OF THE DRAWINGS

FIG. 1A is a block diagram of a networked system suitable for implementing the processes described herein, according to an embodiment;

FIG. 1B is a block diagram including interactions in a networked system suitable for implementing the processes described herein, according to an embodiment;

FIG. 2 is an exemplary system environment utilized by an organization to designate variable user classes and expense policies, according to an embodiment;

FIG. 3A is an exemplary flowchart for authorizing or denying transaction processing on a network based on variable user classes and expense policies, according to an embodiment;

FIG. 3B is a flow diagram including interactions in a networked system for authorizing or denying transaction processing on a network based on variable user classes and expense policies, according to an embodiment;

FIG. 4A is an exemplary interface of a dashboard for employee management of expenses based on variable user classes and expense policies, according to an embodiment;

FIG. 4B is an exemplary interface of a dashboard for administrator management of expenses based on variable user classes and expense policies, according to an embodiment;

FIG. 4C is an exemplary interface of a dashboard for establishing and updating variable user classes and expense policies with an expense management service provider, according to an embodiment;

FIG. 5 is an exemplary interaction between an expense management service provider and an employee device for receipt tracking, according to an embodiment; and

FIG. 6 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for an electronic framework and networked system providing and managing variable class designations and policies. Systems suitable for practicing methods of the present disclosure are also provided.

Generally, in order for banking systems to issue certain payment instruments, such as credit cards, the bank is required to determine the organization's credit worthiness, such as based on the organization's credit history or credit history of its principals or investors. Types of payment instruments may include the credit account, as well as financial accounts with other financial institutions, debit cards, direct debit/credit through automated clearing house (ACH), wire transfers, gift cards, and other types of funding sources. However, with new or emerging businesses, such a history may be unavailable and thus an organization may be prevented from receiving such payment instruments. In contrast to the previous processes to issue and manage company payment instruments and expenses, the online expense management system provides data aggregators that monitor the organization's bank accounts and other financial accounts. The system may therefore utilize information of the organization from an initial setup phase to aggregate data of the organization's funding, amount in accounts, and burn rate of the spend over a time period to determine whether to issue financial instruments to the organization. If approved, the system may further establish expense management policies to manage financial instrument use, monitoring, and approvals for users and groups of users within a company.

Thus, a networked service provider, such as a transaction processing and expense management system, may include a framework and architecture to provide payment gateways, billing platforms, eCommerce platforms, invoicing, and additional services. For example, a service provider may offer services, software, online resources and portals, and infrastructure used to manage an organization's (e.g., a business or company) expenses, purchases, and other financial services. This online system may offer account services to various organizational entities that allow the entities to manage purchasing resources and expenses, as well as issue payment instruments to send and receive payments and otherwise engage in financial transactions on behalf of the entity.

The system may provide an electronic framework that integrates into a payment network and company computing infrastructure that allows for variable user settings, class designations, and expense policies within an expense management system. The system may request establishment of user groups or classes. A user class may correspond to one or more users within a group at the organization. For example, a class may correspond to sales, management, company officers, information technology, etc. There may also be sub-designations within a class, such different tiers or designations within a broader class. Thus, the classes may be designated by title, team, role, location, or other attribute. The organization may further generate expense policies, which may include expense attributes such as global limits, approval limits, restricted/prohibited merchant or purchase types, time period specific limits, approved transaction types, and other limitations, permissions, or rules. Finally, the organization may be required to select payment networks utilized for issuance of payment instruments and transaction processing, which may include payment cards, direct debit, payment wires, or other types of payments. Each of the user classes, the expense policies, and the payment networks may be selected and created for the organization based on automated processes and recommended selections during onboarding of an organization, default or preconfigured selections, or through manual input by an administrator.

The organization may then utilize the framework to make associations between user classes and expense policies so that each user class is associated with one or more expense policies that govern allowed purchases and transaction processing by that user class. A user class may have one policy set generally for the user class, or may have multiple policies where those multiple policies govern different transactions and transaction attributes (e.g., for office purchases, travel, business development, sales meetings, specific locations, etc.). The user classes may also be associated with the types of payment networks available to that user class, which may include payment cards issued to that user class, wire exchanges of funds, etc. In certain embodiments, the framework provided by the expense management system may integrate with an accounting or human resources system of the organization in order to pull data, establish the user classes, policies, and payment networks, and make the associations. In such embodiments, the user classes, policies, and/or networks used in the framework may update over time based on changing data from the organization's systems. Additionally, based on activity over time within a user group or expense policy, the system may recommend changes to the user group or expense policy to account for changes and differences between previous attributes. For example, if a particular user within the organization continually requires authorization for transactions that are not allowed for that user's class, or a user class continually exceeds their global limit but receives approval, the system may recommend updating the user class for the user or move the user to another user class to remedy such issues.

The expense management system's framework established for the organization may then issue or cause to be issued from an associated partner (e.g., an issuing bank that provides credit cards or other financial instrument), one or more payment instruments depending on the user classes and expense policies of the organization. A user, such as an employee, within a user class may then utilize the payment instrument during the course of or associated with business in order to request a payment to a merchant. Merchants (e.g., a seller or payment receiver, such as a business, fundraiser, healthcare provider, landlord, etc.) may correspond to any person or entity selling goods and/or services (referred to herein as an “item” or “items”) to the company's employees. The user may provide the payment instrument on checkout and processing of the transaction. The expense management's system integration within a payment network may occur between the organization's enterprise resource planning (ERP) software and infrastructure, the bank used by the organization, the individual cardholders of the organization, and the issuer (e.g., the financial source of the provided payment instruments on the payment network). This may allow the system to quickly receive data on the network and control expenses with merchants when payments are requested.

In order to process a payment, the expense management system may receive transaction data for the payment request from the payment network, for example, when the acquirer (e.g., the acquiring bank for the merchant that processes the payment instrument provided by the user) requests processing with the issuer (e.g., the issuing bank of the organization and expense management system that issues the payment instrument). This occurs when the user causes a transaction to be generated, and the merchant generates a total for the transaction requests for the user to provide a payment instrument. After receiving the payment instrument, the merchant may cause a payment request to be generated for payment of the transaction. In various embodiments, the user may be required to enter additional checkout information, such as a name, delivery location, or other personal or financial information that may be used by the expense management system for identification of user, class, purchase type/item, location, and/or organization. In some embodiments, the payment instrument may previously be tokenized by the expense management system in order to further protect from fraud, where the digital token allows for backend identification of the payment instrument to the issuer and/or expense management system.

The expense management system may utilize a card or payment instrument identifier, merchant identifier, item identifier, and/or transaction details for the payment request to determine whether to approve or deny the transaction, and whether additional exception management processes may be required to be invoked. In this regard, the system may first determine the organization using the payment instrument identifier or token and may utilize additional user information and/or the payment instrument identifier (where the payment instrument identifier is assigned to a single user or class of users) to determine the user class. Based on the user class, the expense management system may then identify the expense policy (or policies) associated with the payment request, and may approve or deny the payment request/transaction/expense based on the corresponding policy. Where multiple policies correspond to the user group, the expense management system may automatically determine which policy the payment request fits under (e.g., transportation, travel, food, etc.) based on the transaction data (e.g., merchant item, time, etc.) and may process the payment request under that policy.

If the transaction is allowed, the system may instruct the issuer to process a payment using the expense management system, and the expense management system may require payment from the organization's funding account(s). The system may process the payment request by obtaining payment using the payment instrument, which may correspond to withdrawal of the payment amount from a banking account of the organization and/or generating a credit bill for the organization, requesting a transfer from a financial institution, or otherwise obtaining payment. For example, a financial institution, credit provider, or other entity may be utilized by the system to receive the payment amount from the organization after integration with the organization's bank. However, if the payment request exceeds, violates, or otherwise does not comply with the policy for the user class requesting the payment, the system may decline the payment, or may implement one or more processes to receive an authorization, as discussed further herein. Thus, the system may automate real-time approvals/denials of transactions without requiring review and/or intervention by an administrator.

In various embodiments, the expense management system may be set up to allow for different authorizations and/or limit expense policies based on additional data provided with the payment request and/or previous transactions. For example, the payment request may correspond to multiple employees in a user class, or multiple employees having different user classes. Where there are multiple employees in a single user class, a policy may allow for group spending that increases a total allowable spend (e.g., on a single item or over a time period), such as multiple members of a sales team, and therefore the system may increase a budget allowed for the payment request and approve the payment request that exceeds a maximum spend of a single user in a user class. Where employees belong to different groups, the system may select the most compatible policy (e.g., one with the most overlap or total qualified amount of the group) or largest dollar amount policy that allows the payment request where it may be otherwise declined. Moreover, the system may utilize watermarks or minimum and/or maximum dollar amounts (which may be weekly, monthly, or other per-time period) to allow for transaction processing, decline transaction processing, and/or alert an administrator of particular transactions. For example, a first low watermark for a user class may be set at $1,000 of allowable spend, under which, a user class is allowed any purchase or allowed to purchase up to over a monthly total. A higher watermark of $5,000 may automatically decline any purchase over that amount. However, between $1,000-$5,000, the user class is allowed purchases, but the system may flag such purchases for review by the user class and/or an administrator.

The expense management system may further provide for management of exceptions related to expense policies for user classes. For example, the system may be configured to allow access to team leaders, administrators, company officers, or other expense authorization figures that allow for pre-approvals or pre-authorizations to be set with the system. Thus, if the system receives a processing request for a payment that exceeds an expense policy for the user class of the user, the system may further determine whether any pre-approvals exist that may allow the transaction. The pre-approvals may be tied to a specific user, for example, through a user or payment card identifier tied to that user. In other embodiments, the pre-approval may be tied to a user class, and may therefore allow one or more users within that user class to make payments that would normally exceed the limitations from the policy for that user class.

The expense management system may also provide for approvals or denials at the time of the payment request, which may be used to receive authorization or denial for the payment request and/or hold the payment request pending for review and later approval/denial of the payment request. An exception management process may allow for the user, merchant, and/or system to contact an approval administrator, such as a team leader, accounting member, company officer, or other administrator, at the time of the payment request if the payment request does not comply with the user's policies for their user class. The notification may include a process that allows the administrator to approve or decline the transaction, and may be transmitted through the system, an electronic communication, and/or posted to a dashboard, application interface, or online portal for the system. The approval request may expire after a certain time period or may be left open for later review. Moreover, the system may either receive identification of the administrator or determine the administrator based on available settings and designations for the user classes, organization, or approval administrators. The administrators may also designate times of availability, or the system may determine online availability, activity, or communications to determine which administrators may be available at the time.

The expense management system may also provide a dashboard having one or more graphical user interfaces (GUIs) that allow for expense management, user class/policy/payment network adjustment and update, and/or authorization issuance/tracking. This dashboard may further include a cardholder statement for the organization, each team or user class, and/or individual users in order to review purchases and adjust expenses tied to each group of users. The dashboard may include one or more fields, menus, or processes to review expenditures, allow/deny approval requests, request reimbursement from an employee for an unapproved transaction, and/or adjust user classes and policies. The dashboard may be specific to particular users, where the processes are different for each user and information may be hidden/revealed based on the user's title, job, or permissions. Thus, a company officer may be able to review company purchases, per-team/user class purchases, and individual purchases, as well as make adjustments and perform other administrative processes, while a sales team member may be only able to review their purchases.

In order to further provide accounting and auditing services to enforce user class policies and prevent abuse/fraud, the system may further include a receipt tracking process that may perform reverse matching to associate receipts with transactions. At the time of receiving a payment request, processed transaction, or other transaction data from the network, the expense management system may transmit an electronic message (e.g., email, Short Message Service (SMS) or Multimedia Messaging Service (MMS) text message, instant message, etc.) to the user's device that is associated with the payment card identifier associated with the payment request for the transaction. The message may request that the user image or capture the receipt for the recent transaction. The user may then image, such as through a camera device or functionality on the user device, the receipt and transmit back the image. Utilizing optical character recognition (OCR) and/or other data parsing and image processing, the system may determine and match the data in the receipt to the transaction data received over the payment network. Due to the temporal locality of the two actions (e.g., the receipt of the transaction data and the receipt of the image), the system may have a higher confidence that the receipt belongs to the transaction. As such, systems and methods are provided to enable a company to better manage electronic transaction requests from its employees and contractors in real-time to reduce fraud and computing resources typically required with conventional systems.

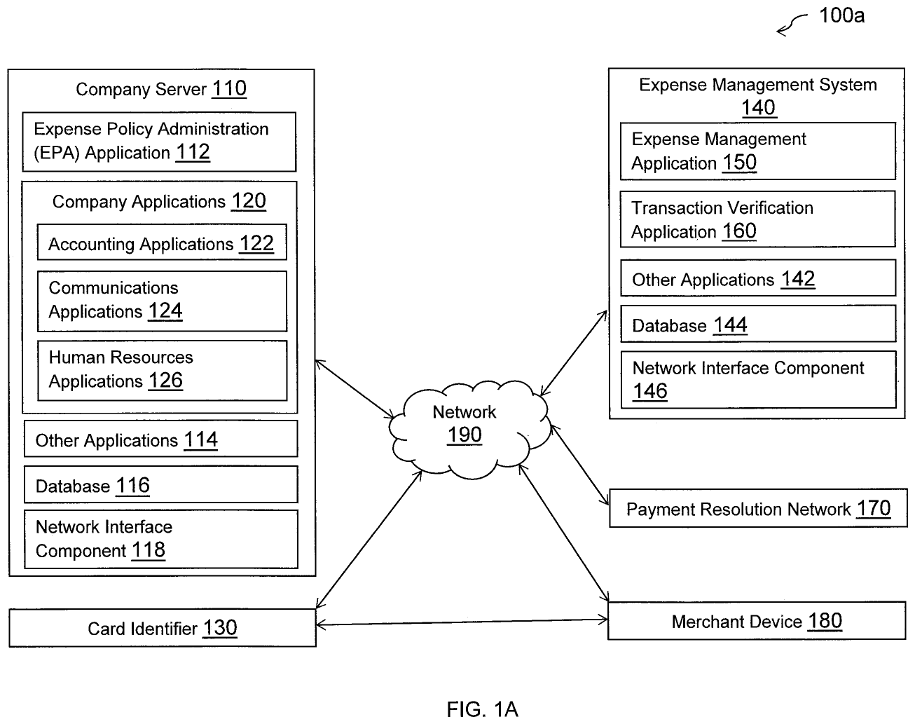

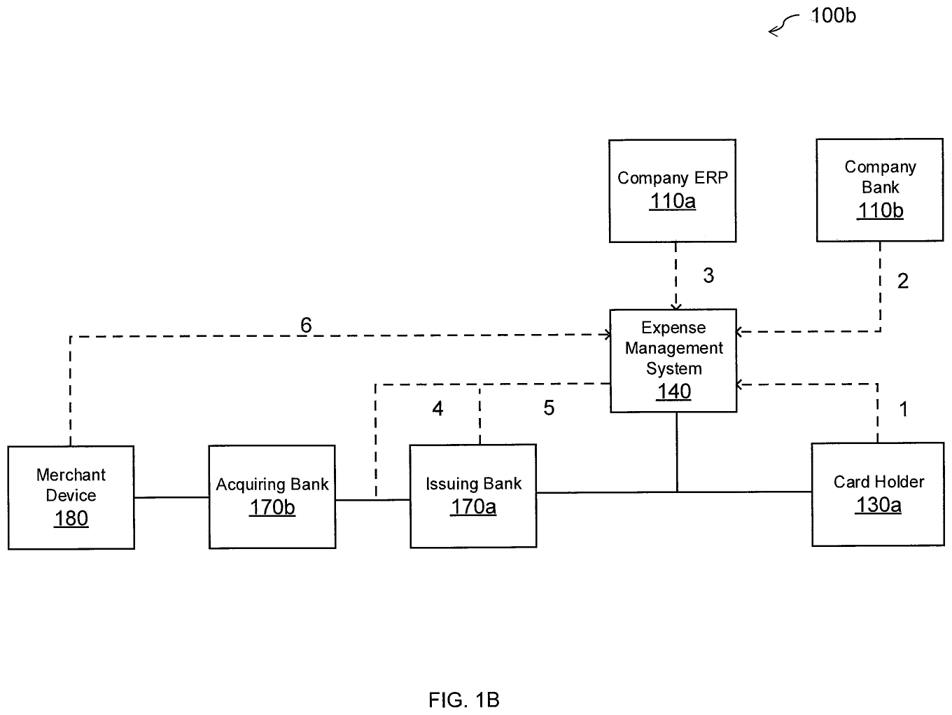

FIG. 1A is a block diagram of a networked system 100a suitable for implementing the processes described herein, according to an embodiment. As shown, system 100a may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1A may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100a includes a company server 110, a card identifier 130, an expense management system 140, a payment resolution network 170, and a merchant device 180 in communication over a network 190. A user (not shown) may correspond to an employee of a company (not shown) associated with company server 110, which may utilize card identifier 130 to submit purchase requests for items to be paid using company funds. Card identifier 130 may correspond to a payment instrument allowing for purchase of items using company funds, which may be provided and managed by expense management system 140. Company server 110 may therefore request an expense management framework be established by expense management system 140, where the expense management framework may include variable user class designations and expense policies for payment instruments processed using payment resolution network 170. Thus, when card identifier 130 is used with merchant device 180 to submit a purchase request for an item, the framework provided by expense management system 140 may receive data for the request from payment resolution network 170 and may approve, decline, or perform a follow up action with an issuing bank on payment resolution network 170 or with the user or company (including its authorizing representatives) through company server 110 or other means.

Company server 110, expense management system 140, and merchant device 180 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100a, and/or accessible over network 190.

Company server 110 may be maintained, for example, by an organization or company that employs one or more users, which may require payment instruments issued by a bank, credit providing entity, or an issuing and expense management entity, such as expense management system 140. In this regard, company server 110 includes one or more processing applications which may be configured to interact with expense management system 140 to manage payment instruments provided by expense management system, establish user classes and expense policies, and control expense policies during use of the payment instruments. In some embodiments, company server 110 may be maintained by, or include various types and sizes of companies from smaller and startup companies to large enterprises.

Company server 110 of FIG. 1A contains an expense policy administration (EPA) application 112, company applications 120, other applications 114, a database 116, and a network interface component 118. EPA application 112, company applications 120, and other applications 114 may correspond to executable processes, procedures, and/or applications with associated hardware. In other embodiments, company server 110 may include additional or different modules having specialized hardware and/or software as required.

EPA application 112 may be implemented as specialized hardware and/or software utilized by company server 110 to provide an interface to permit an administrator associated with company server 110 to select expense policy options and obtain payment instruments for use with the expense policy options. In various embodiments, EPA application 112 may include a general browser application configured to retrieve, present, and communicate information over the Internet (e.g., utilize resources on the World Wide Web) or a private network. For example, EPA application 112 may provide a web browser, which may send and receive information over network 190, including retrieving website information, presenting the website information to the user, and/or communicating information to the website, including payment information. However, in other embodiments, EPA application 112 may include a dedicated application of expense management system 140 or other entity, which may be configured to assist in establishing and maintaining user classes, expense policies, and payment networks. EPA application 112 may access expense management system 140 for the establishment of user classes, policies, and payment networks, which may be present through a dashboard including one or more GUIs. Additionally, EPA application 112 may receive and display data from expense management system, such as the results of transaction processing (e.g., a receipt, statement history, etc., for one or more user classes and/or the company). EPA application 112 may then be used to control and modify user classes, expense policies, associations of the two, and payment networks. In some embodiments, EPA application 112 may be used for exception managements, such as the submission of pre-authorizations and/or obtaining approvals for submitted payment requests.

Company applications 120 may be implemented as specialized hardware and/or software utilized by company server 110 to provide company-wide applications that may be utilized during expense management with expense management system 140. In this regard, company applications 120 may correspond to ERP resources and management software, hardware, and other infrastructure for a company corresponding to company server 110. Company applications 120 include accounting applications 122, communications applications 124, and human resources applications 126. Accounting applications 122 may be used to integrate an expense management system with financial and accounting services of ERP resources and infrastructure of the company associated with company server 110. Accounting applications 122 may provide data for funds, payments, and funding burn rate of the company used by expense management system 140 when issuing payment instruments, managing expenses, and providing additional services to the company.

Communications applications 124 may be utilized for communications between employees, officers, departments, and other entities within the company, and may be utilized when providing notifications of approved/denied/held payment requests, expenses and statements, and expense limitations and usage of available expense funding. Additionally, communication applications 124 may be utilized to determine and request permission or approval of payment requests that may violate an expense policy for the user class requesting the payment, which may include determining availability and communication channel usage for an administrator that may approve a request. Human resources applications 126 may correspond to applications providing employee data, teams, positions, and/or other data necessary for determination and adjustment of user classes for employees at the company. In this regard, human resources applications 126 may be accessed and used to generate the user classes, update the user classes, and add or move employees within user classes at the company by expense management system 140 based on changing employee data.

In various embodiments, company server 110 includes other applications 114 as may be desired in particular embodiments to provide features to company server 110. For example, other applications 114 may include security applications for implementing server-side security features, programmatic client applications for interfacing with appropriate application programming interfaces (APIs) over network 190, or other types of applications. Other applications 114 may contain software programs, executable by a processor, including a graphical user interface (GUI), configured to provide interfaces to the administrators when accessing one or more processes or receiving and displaying data associated with expense management system 140.

Company server 110 may further include database 116 stored in a transitory and/or non-transitory memory of company server 110, which may store various applications and data and be utilized during execution of various modules of company server 110. Thus, database 116 may include, for example, identifiers such as operating system registry entries, cookies associated with EPA application 112, company applications 120 and/or other applications 114, identifiers associated with hardware of company server 110, or other appropriate identifiers, such as identifiers used for payment/user/device authentication or identification. Database 116 may include data received from expense management server 140, such as payment request data, cardholder statements, approval requests, and the like, as well as data transmitted to expense management system 140 (e.g., data from EPA application 112 and/or company applications 120).

Company server 110 includes at least one network interface component 118 adapted to communicate with expense management system 140, payment resolution network 170, and/or merchant device 180. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices.

Expense management system 140 may be maintained, for example, by an online service provider, which may provide payment instruments and expense management services to companies. In this regard, expense management system 140 includes one or more processing applications which may be configured to interact with company server 110, payment resolution network 170, and merchant device 180 to facilitate processing of payments and enforcement of expense policies for payment instruments, such as ones associated with card identifier 130. In one example, expense management system 140 may be provided by BREX®, Inc. of San Francisco, Calif., USA. However, in other embodiments, expense management system 140 may be maintained by or include other types of credit providers, financial services providers, and/or other service provider, which may provide expense management services to companies.

Expense management system 140 of FIG. 1A includes an expense management application 150, a transaction verification application 160, other applications 142, a database 144, and a network interface component 146. Expense management application 150, transaction verification application 160, and other applications 142 may correspond to executable processes, procedures, and/or applications with associated hardware. In other embodiments, expense management system 140 may include additional or different modules having specialized hardware and/or software as required.

Expense management application 150 may correspond to specialized hardware and/or software to allow companies to receive payment instruments associated with a bank account and funding of the company, such as one or more company credit cards, and provide expense management for those issued payment instruments and additional funds/accounts of the company. In this regard, a company may first establish an account with expense management system by providing company data and onboarding through expense management application 150. Such information may include bank account and funding information, such as verified funding from investors, available funds directly in an account, and burn rate of company funds over a time period. If qualified, expense management system 140 and/or another issuing entity may provide a payment instrument that is managed by expense management application 150. For example, expense management system 140 may issue card identifier 130 for a real or virtual credit card, or may issue other types of payment instruments and instrument identifiers that may be used for company payments.

Expense management application 150 may provide one or more processes accessible by an administrator of an organization using company server 110 to establish settings and preferences necessary for the enforcement of expense policies and approvals/denials of payment requests using an issued payment instrument, such as card identifier 130. In this regard, the administrator may first generate user classes with expense management application 150, which may correspond to attributes for one or more employees within a particular user class at the company. The attributes and/or user classes may be selected by default and/or through automated user class settings provided by expense management application 150 (e.g., generic “sales” or “officer” classes, which may intelligently be provided based on company information) or may be established through manual input by the administrator. The administrator may next select expense policies, which correspond to attributes for allowable spend under that policy, such as maximum purchase amount, maximum spend over a time period, merchant/item types, location, hours of purchase, etc. Expense management application 150 may provide default or automated options intelligently based on company size, past history, company space or type, sector, or other company information, or expense management application 150 may receive manual input for selection of the policies.

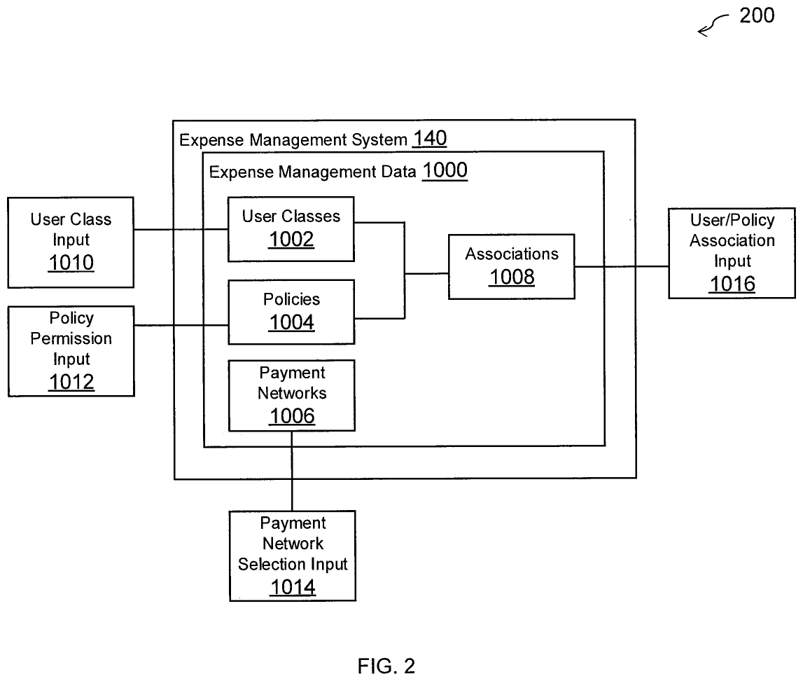

Expense management application 150 may be used to make associations between user classes and expense policies so that each user class is associated with at least one expense policy and the employees of the company therefore are placed in a user class to access an expense policy (or access no policy where a user class has no purchasing power). The administrator may be required to select one or more payment networks available to expense management system 140 through expense management application 150, which may include default or automated selection, as well as manual selection of specific payment networks. Expense management application 150 may also be used to update and change expense policies based on transaction data and/or employee/financial data changes from company server 110. The additional functionality and processes provided by expense management application 150 are described in more detail with regard to the additional Figures of the application, such as FIG. 2.

Transaction verification application 160 may correspond to specialized hardware and/or software to receive a payment request and approve or deny the payment request based on expense policies established for a company associated with company server 110 using expense management application 150. Transaction verification application 160 may receive a payment request from merchant device 180 for a transaction between a user at the company associated with company server 110 and the merchant The payment request may include transaction terms and card identifier 130 provided by the user. In order to process the transaction, transaction verification application 160 may perform an initial authentication or verification step of the user and card identifier 130. Transaction verification application 160 may then determine the company associated with card identifier 130, and further determine the user class for the user based on the company, a user identifier, and/or card identifier 130.

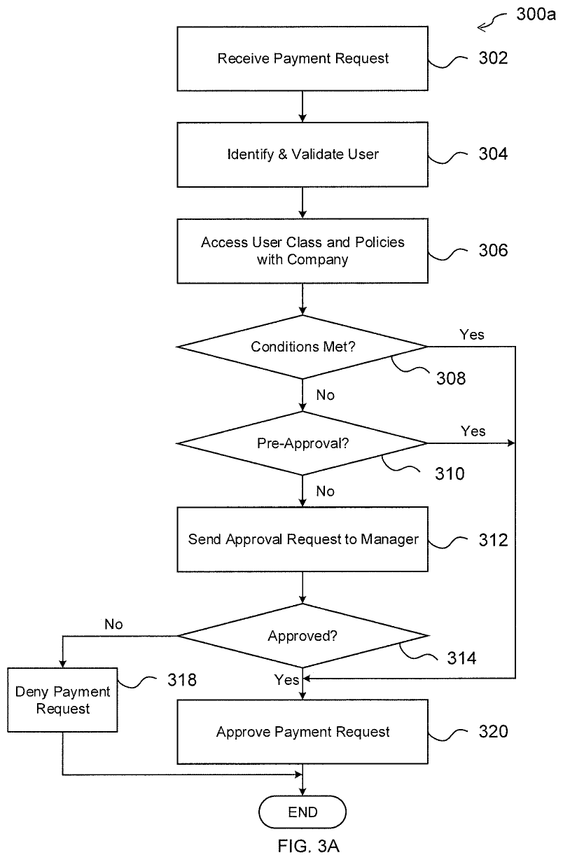

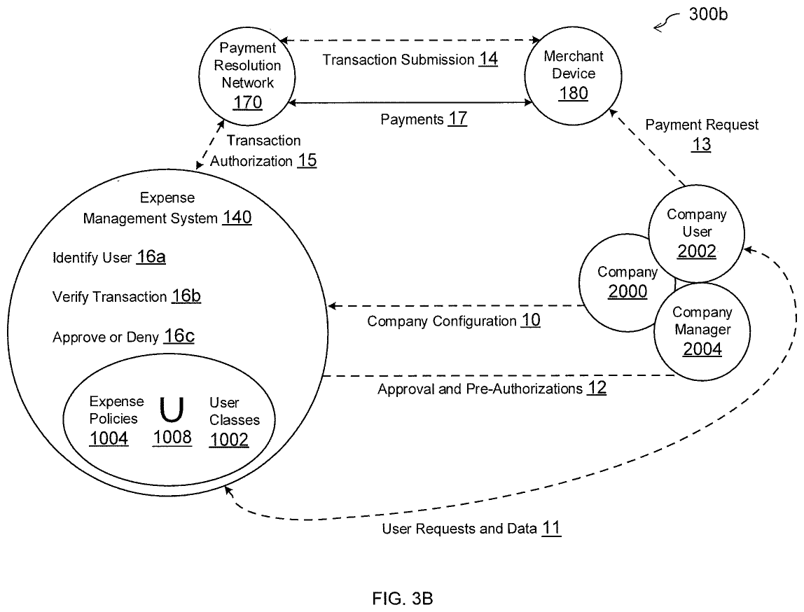

Once the user class is determined, one or more expense policies may be determined for the user class. The expense policies may be determined through user class to expense policy associations. Transaction verification application 160 may determine whether conditions or parameters of the expense policy are met. If so, the payment request may be verified and processed using payment resolution network 170. However, if not, transaction verification application 160 may proceed to check pre-approvals that may validate the transaction and/or request an approval from a manager or other administrator. If approved through either approval mechanism, transaction verification application 160 may approve the payment request. However, if not, the payment request may be denied. Additionally, transaction verification application 160 may be used to transmit one or more notifications to employees, managers, and/or administrators using company server 110 and/or another communication channel, where the notification may be related to transaction amounts, approvals, and/or expense management. Transaction verification application 160 may be used to receive and provide transaction histories and receipts, including performing receipt matching. The additional functionality and processes provided by transaction verification application 160 are described in more detail with regard to the additional Figures of the application, such as FIGS. 3A and 3B.

In various embodiments, expense management system 140 includes other applications 142 as may be desired in particular embodiments to provide features to payment provider server 134. For example, other applications 142 may include security applications for implementing server-side security features, programmatic client applications for interfacing with appropriate application programming interfaces (APIs) over network 190, or other types of applications. Other applications 142 may contain software programs, executable by a processor, including a graphical user interface (GUI), configured to provide an interface to the user when accessing payment provider server 134.

Additionally, expense management system 140 includes database 144. As previously discussed, the entity corresponding to company server 110 may establish one or more accounts with expense management system 140. Payment accounts in database 144 may include entity information, such as name, address, payment/funding information, additional user financial information, and/or other desired user data. The entity may establish expense controls and policies for their company that may be stored in database 144. Database 144 may also be used to store information on issued payment instruments to the company, as well as associations between payment instruments, users, user classes, expense policies, and payment networks.

In various embodiments, expense management system 140 includes at least one network interface component 146 adapted to communicate company server 110, payment resolution network 170, and/or merchant device 180 over network 190. In various embodiments, network interface component 146 may comprise a DSL (e.g., Digital Subscriber Line) modem, a PSTN (Public Switched Telephone Network) modem, an Ethernet device, a broadband device, a satellite device and/or various other types of wired and/or wireless network communication devices.

Payment resolution network 170 may correspond to a network utilized for resolution of payment requests and electronic transaction processing, which may be governed by permissions (e.g., acceptances and denials) of payment requests for transaction processing by expense management system 140. In this regard, payment resolution network 170 may correspond to a credit card or debit card network where an acquiring bank or entity may interact with an issuing bank or entity for the resolution of a payment using card identifier 130. However, in other embodiments, payment resolution network may correspond to other types of payment networks and payment types, such as direct debit payments (ACH payments), wire exchanges or payments, prepaid card payments, or regionally/company-specific payments. Payment resolution network 170 may be implemented by expense management system 140 on request by company server 110, and may allow authorized users (e.g., users and user classes) to interact with the network to submit payments and process transactions, allow third parties (e.g., banks or other financial service intermediaries) to interact on the network on behalf of the user, and/or access or use data provided to or from the payment network, such as notifications of transactions and details that allow authorizing or declining transactions. Thus, expense management system 140 may utilize payment resolution network 170 in the managing, approval, denial, and data gathering associated with payment requests using company issued payment instruments associated with payment resolution network 170, such as card identifier 130. In some embodiments, payment resolution network 170 may include or be connected with an online banking resource for a bank utilized by expense management system 140 to resolve fees and payments processed by expense management system. Payment resolution network 170 is described in more detail with regard to FIG. 1B.

Merchant device 180 may be maintained, for example, by a merchant or other entity selling one or more items to users, which may include single users or groups of independent users as well as small and large merchants. Merchant device 180 may provide the items for sale, including use of various software, infrastructure, websites, applications, and/or other platforms for advertisement, sale, and payment processing. In this regard, merchant device 180 may include a device having processing applications, which may be configured to interact with company server 110, expense management system 140, and/or payment resolution network 170 to engage in transactions using card identifier 130. In some embodiments, merchant device 180 may be implemented as a single or networked personal computers (PCs), a smart phone, laptop computer, wearable computing device, and/or other types of computing devices. Although only one merchant device is shown, a plurality of merchant devices may function similarly.

Merchant device 180 may be implemented with an application offering items for sale that may be accessed by a computing device to present the items for sale to the user associated with card identifier. In certain embodiments, the application may provide a website available over the Internet and/or online content and/or database information accessible through a dedicated application. Thus, the application may provide item sales through an online marketplace using the website of the merchant. The application may also correspond to a checkout application at a physical merchant location, such as the application(s) of a point-of-sale (POS) device used to provide sales at physical locations. Merchant device 180 may be used to establish a transaction once a user/employee associated with company server 110 has selected one or more items for purchase. Once a payment amount is determined for the item(s) to be purchased by the user, merchant device 180 may request payment using card identifier 130. After input, merchant device 180 may then process a payment to the merchant associated with merchant device 180 using card identifier 130 and payment resolution network 170. Expense management system 140 may utilize network integration with payment resolution network 170 to manage an expense policy (or policies) for a user class associated with the user. Thus, expense management system 140 may approve or deny the payment request based on the policies for the company associated with company server 110. The payment request may then be processed, payment provided to the merchant account, and notification of payment (or failure, for example, where the payment request is non-compliant with the company policies) may be sent to merchant device 180. Merchant device 180 may then receive the results of the transaction processing, and complete the transaction with the user, for example, by providing the user the items for the transaction or declining the transaction where the user does not have authorization.

Network 190 may be implemented as a single network or a combination of multiple networks. For example, in various embodiments, network 190 may include the Internet or one or more intranets, landline networks, wireless networks, and/or other appropriate types of networks. Thus, network 190 may correspond to small scale communication networks, such as a private or local area network, or a larger scale network, such as a wide area network or the Internet, accessible by the various components of system 100a.

FIG. 1B is a block diagram including interactions in a networked system suitable for implementing the processes described herein, according to an embodiment. Note that one or more of the interactions described herein may be omitted, performed in a different sequence, or combined as desired or appropriate. As shown, system 100b may comprise a plurality of devices, servers, and/or software components that operate to perform various methodologies in accordance with the described embodiments.

In system 100b, the interactions between the various entities are shown in order to establish and enforce expense policies for a company. For example, a company may be associated with company ERP 110a and company bank 110b that provides information for company funding and account. Initially, cardholder data may be shared at step 1 between a cardholder 130a (e.g., the company and company employees that have access to a credit card or other payment instrument) and expense management system 140. This cardholder data may correspond to company and employee information and may be used to identify user classes and attributes, as well as assign employees to one or more user classes. Onboarding may occur when company bank 110b integrates with expense management system 140 and shares bank data from linking bank accounts at step 2, which allows expense management system 140 to determine whether to issue payment instruments, and the terms of the payment instruments (e.g., limits, statement balances and repayment terms, etc.). Additionally, expense management system 140 may integrate with ERP software and framework from company ERP 110a in order to further obtain cardholder data and accounting information for the establishment of user groups, expense policies, and payment networks, as well as review and manage company accounting of funding and expenses for issuance of payment instruments, at step 3. Cardholder data provided at steps 1 and/or 3 may also include merchant categorization data, which may be used to classify merchants for incoming expense requests.

As shown in system 100b, integration of an electronic framework provided by expense management system 140 occurs within a payment network shown in system 100b between cardholder 130a, issuing bank 170a, and acquiring bank 170b. This allows expense management system 140 to receive payment requests and other transaction data in real-time at the time of a transaction, and then make real-time decisions of whether to allow, take additional actions, or deny a payment request at the time of the transaction. A payment request may be assigned to varying user classes and expense policies, and management of expense policies occurs at transaction time and not after transaction processing, which may cause fraud, unwanted expenses, and employee liability for unauthorized payments. Additionally, since limitations may be enforced in real-time as transactions occur, expense management system 140 may further allow the company to set limits, pre-approvals, and change user classes, which is immediately effective with expense management system 140.

Thus, expense management system 140 is shown as receiving and transmitting data within the payment network of system 100b between issuing bank 170a and acquiring bank 170b. For example, network integration at step 4 may allow for expense management system 140 to receive network data on the payment network, including transaction data for payment requests, when the network data is passed between issuing bank 170a and acquiring bank 170b. Prior to step 4, cardholder 130a (e.g., an employee at the company corresponding to cardholder 130a) may request processing for a transaction with merchant device 180. Merchant device 180 may receive a payment instrument from cardholder 130a, which includes an identifier matching a user group, expense policy, payment network, and/or expense approval with expense management system 140. When the payment request is electronically transmitted to acquiring bank 170b (e.g., a merchant's bank for receiving payments), acquiring bank 170b may request remittance from issuing bank 170a (e.g., the bank that issued the payment instrument). However, network integration allows expense management system 140 to receive network data at step 4. Thus, at step 5, expense management system 140 may control authorizations and approve or decline the payment request directly with issuing bank 170a based on communications with issuing bank 170a. The authorizations may be based on expense policies established by the company with expense management system 140 and may therefore provide real-time control over expenses when the expenses occur. Expense management system 140 may also provide for electronic communications with merchant device 180 in order to receive receipts and transaction histories, which may be matched to incoming processed payment requests by issuing bank 170a, as well as request and receive receipt images from cardholder 130a.

FIG. 2 is an exemplary system environment utilized by an organization to designate variable user classes and expense policies, according to an embodiment. System environment 200a of FIG. 2 includes expense management system 140 discussed in reference to systems 100a and 100b of FIGS. 1A and 1B, respectively.

In system environment 200a, expense management system 140 establishes, controls, and utilizes expense management data 1000 for a business entity, company, or other organization. After receiving a request for enrollment, onboarding, and/or expense management from the company, expense management data 1000 may be established by various inputs during the course of onboarding the company and further establishing expense policies for payment instruments provided by expense management system 140. User classes 1002 may be established based on user class input 1010, which may correspond to manual input from an administrator of the company that establishes user class attributes (e.g., title, name, role, location, reporting line, etc.), members, managers or administrators, and other information. Any manual input may be made through a user interface provided by expense management system 140, and removals or changes may require further input or may be determined using integration with a human resources system of the company. Automated onboarding may occur through integration by expense management system 140 with an ERP system providing a corporate directory of the company and/or a human resources system providing employee data of the company. Expense management system may require at least one user class for user classes 1002 and may further use external validation through company email to create a user profile and ensure the user is within the user class (e.g., based on title, position, office location, job requirements, etc.).

In one embodiment, expense management system 140 may provide recommendations during the onboarding process or any time subsequent to that based on available data, such as about the company and/or about its competitors. Recommendations that may be generated by expense management system may be based on the size of the company, company funding, industry space of the company, assets and debts, similar companies in the area and in the industry, financial strength of the company, anticipated growth, or other company information. Additionally, expense management system 140 may continuously adjust recommendations or provide new recommendations based on changing company data. For example, if the company receives additional funding, grows or expands into a new industry, or otherwise changes, expense management system may change the recommendations or provide new recommendations for expense management by the company.

Policies 1004 may then be established to control expense policies for user classes 1002, which may also be effective depending on payment networks 1006. Policy permission input 1012 may be used to establish policies 1004. Policy permission input 1012 may include manual input of rule data and rule sets of expenses and payments by company employees, as well as default and automated policy configuration and selection. Rules may depend on specific attributes unique to a payment network, location, team, company, or other factors. A rule set may at least designate a user class and a spending limit and may default to a payment network selected for all users. However, rule sets selected by administrators may be more complex depending on needs of user classes and the company. Such factors may include global company or team limits for user classes, approval flows for a given user or user class, specific payment types and payment networks, limitations with specific merchants or merchant categories, different levels of spend based on office or user class location, predefined permissions and authorization flows for existing human resource/ERP systems. The rules may also set different limits based on specific situations, such as a convention the company is attending and/or specific types or vendors the company is targeting. As such, different rules/limits may exist at different times and places and with different groups.

Thus, while manual input may be used as policy permission input 1012 to establish policies 1004, out-of-the-box or default expense policies may be provided depending on company characteristics and other similar companies. Additionally, default users classes (such as executive, sales reps, accounts payable, facilities, etc.) may have default characteristics. Automated policy configuration may also be accomplished through existing systems, such as existing human resource or ERP systems. Policies 1004 may be updated at any time and immediately become effective, for a certain time period or until a further update is warranted. For example, if the system knows, either historically or based on an upcoming event, that the company has employees who may need to spend more than what is allowed in their usual class, the system may make suggestions or ask approval for the company to adjust rules/limits, including placing certain employees temporally into a different class. After this, those employees may be put back in their previous class(es) with the previous limits/rules. Moreover, changes to a higher-level expense policy that incorporates multiple user classes or expense policies may affect the downstream expense policies so as to allow for high level changes to waterfall down to lower policies and user classes.

Payment networks 1006 may be selected using payment network selection input 1014 that determines payment instruments available to company employees and allows payment processing. Payment networks 1006 may include more than one payment network, where different payment networks may be utilized by different ones of user classes 1002 based on policies 1004. For example, payment networks 1006 may include a credit card network and a wire transfer network, where the wire transfer network is only available to company officers based on policies 1004. When providing payment network selection input 1014, automated or manual selection may again be utilized by the administrator. Manual selection may allow for specification of the desired payment types and networks available for the company and may establish permissions for use of those networks. Automated selection may allow the administrator to select out of the box or preconfigured payment networks, for example, based on the characteristics of the company. This allows authorized users in user classes 1002 to transact on payment networks 1006, instruct third parties to transact on behalf of the user/company on payment networks 1006, and/or access data on payment networks 1006. Payment networks 1006 may include those payment networks that are not supported by expense management system 140 but allow expense management system to track and obtain transaction data.

After designation of the aforementioned information, associations 1008 between user classes 1002 and policies 1004 may be generated using user/policy association input 1016. User/policy association input 1016 may require an administrator to manually associate user classes 1002 with policies 1004, as well as select payment networks 1006 for certain ones of policies 1004. However, in other embodiments, based on automated or default user classes 1002 and policies 1004, user/policy association input 1016 may automatically create associations 1008. The company may assign each of policies 1004 to multiple user classes 1002, or each of user classes 1002 may have multiple policies 1004. Additionally, users may belong to multiple user classes 1002, and therefore may have multiple associations 1008 with policies 1004. Once associations 1008 are defined, each user in user classes 1002 may be required to be defined and validated through user information, such as a name, email address, phone number, title, employee identification, or reporting line/manager, and an authentication mechanism (e.g., a single sign on (SSO) or a system-provided authentication mechanism (e.g., multifactor authentication using a mobile device)). Additionally, expense management data 1000 may be updated and changed based on internal data for expense management system 140 and/or additional input and updates from the company.

FIG. 3A is an exemplary flowchart for authorizing or denying transaction processing on a network based on variable user classes and expense policies, according to an embodiment. Note that one or more steps, processes, and methods of flowchart 300a described herein may be omitted, performed in a different sequence, or combined as desired or appropriate.

At step 302 of flowchart 300a, a payment request is received by the system, such as expense management system 140. Generally, after issuance of payment instruments to employees of a company, these employees/users have the ability to transact using that payment instrument based upon the rule set for the expense policies applicable to their user class(es). At step 304 of flowchart 300a, the user is identified and validated using transaction data received with the payment request. The transaction data may include an identifier for the payment instrument, and additional merchant, item, user, or other transaction identifiers or information. Thus, the transaction data may allow for identification of the user and initial validation or authentication of the user. Step 304 may further include determining the user's organization or company for use in identifying and validating the user.

At step 306 of flowchart 300a, the user class and policies with the company are accessed. Where only one user policy applies to the user's class(es), the single policy may be accessed. The user may also belong to a single user class that has more than one policy associated with that user class, or the user may belong to multiple user classes having multiple policies. At step 308 of flowchart 300a, the system may then determine if the conditions from the expense policy are met, satisfied, or the rule set is otherwise not violated (e.g., the transaction data for the payment request complies with the rule set). Expense policies may have a notion of priority so that one expense policy may override or preempt any other policies, where the most permissive rule applies and is accessed for the transaction data. For instance, if the user belongs to a sales class and executive user class, if sales only receives $20 a day in food expenses but executives are provided $100, the executive expense policy may apply and be accessed. In other embodiments, priority rules or limits may be additive so that if a transaction request applies to two or more policies/classes, the limit to the transaction is set as a sum of the limits of the two or more policies/classes instead of just the highest or most permissive of the policies/classes. However, overriding rules may also impact use of the payment instrument regardless of user class. For example, if a particular merchant is barred by the company, all transactions may still be refused with that merchant. Additionally, some expense policies may override even if they are more restrictive based on transaction data. For example, if an executive belongs to an executive user class set for San Francisco that allows $100 daily for food, and an executive user class set for Dallas that allows $75 daily in food, the executive may be restricted to $75 daily in food when in Dallas. When a transaction affects two or more contradicting policies, the system may have conditions set that determine which policy applies. For example, if an executive has a policy of $100 limit per social meeting with a client and another policy of $50 for drinks with a client, the company may set rules that the higher limit always applies to executives, but the lower limit applies to non-executive classes.

If the conditions are met, then flowchart 300a may proceed to step 320 where the payment request is approved. However, the conditions may not be met to approve the payment request, and flowchart 300a may proceed to step 310 where the system determines whether a pre-approval has been issued with the system and is available to approve the payment request. Pre-approval requirements allow for certain transactions to be approved even if they violate an expense policy. An administrator, officer, group leader, manager, etc. may require or authorize certain purchases for user class members that violate expense policy. Thus, at step 310, if such an authorization with the system is set, the system may proceed to step 320 and approve the payment request without any further action required by the user or a manager. Where there is a direct integration with a payment network, either through the system or through third parties, pre-approval may directly allow the payment request to be approved. However, in a loosely integrated network, the system may be used to record the transaction after approval and maintain details. For example, a user may identify that a $100,000 piece of hardware is required. If approved, in a tight or direct integration of the system with the payment network, the transaction would only clear on approval by the system. However, in more loosely integrated networks, the transaction may still be cleared prior to obtaining all approvals, but the system may track and record the payment request for internal approvals.

If a pre-approval is not found at step 310, flowchart 300a may proceed to step 312 where an approval request is sent to a manager or other administrator having approval authority for the transaction. Companies may always require a process for manual approval of expenses so that any deviations can be documented and auditable. Thus, the system may provide a communication process to alert one or more other users at the company and request approval. This may be posted to an approval dashboard or portal or may be directly communicated to a device of the user (e.g., through email, text message, push notification, etc.) and/or administrator. The system may intelligently determine available administrators or may access preferences for those administrators of when they are available to be contacted to approve payment requests. The user may also select particular managers or administrators to receive the approval request, where the particular manager would be the one(s) most likely to respond, such as based on their calendar, time of day, communication channel, history of response, and the like.

For example, the system may determine a person at the company having approval authority based on rules and permissions set with the system when establishing expense policies. The system may also identify the person through additional data accessible by the system. The additional data may include data of available users at the company at a specific time, their likelihood of response (e.g., if the users are currently in an office or utilizing a computing device), and/or whether the user able to review transaction data for the transaction requiring approval. The user that may be able to perform the approval may be set for a specific user class and/or expense policy, or may be established generally for the company, such as a chief financial officer or finance/accounting department personnel. Thus, the system described could have an optional exception process that could be managed by administrators at step 312, such that the process would be documented. Additionally, a global “exception” expense policy could be created and applied to user classes or all users that require a specific flow based on amount and authorizing person. For example, exceptions up to $1000 may require manager approval, over $1000 but less than $10,000 require division head approval, and over $10,000 require approval from the chief financial officer.

If the manager or other authorized person provides approval at step 314, flowchart 300a may proceed to step 320 where the payment request is approved. However, if there is no approval or the approval request expires after a predetermined time period, flowchart 300a may proceed to step 318 where the payment request is denied. The payment request may be documented so that potential fraud or system abuse may be monitored. Additionally, the payment request may be monitored so that if the payment request was valid but denied due to system error or lack of approval, the payment request may be revived and resubmitted for review.

FIG. 3B is a flow diagram including interactions in a networked system for authorizing or denying transaction processing on a network based on variable user classes and expense policies, according to an embodiment. Note that one or more steps, processes, and methods of flowchart 300b described herein may be omitted, performed in a different sequence, or combined as desired or appropriate.

FIG. 3B shows interactions between system entities when establishing expense policies and enforcing those policies for a company 2000. In this regard, expense management system 140 may perform an initial company configuration interaction 10 that allows the company to establish company user classes, expense policies, associations between the two, and available payment networks for payment processing. The processes performed at company configuration interaction 10 is described in more detail with reference to FIG. 2. After configuring company 2000, expense management system 140 may further allow a company user 2002 and a company manager 2004 to utilize payment instruments for expenses with company 2000. For example, company user 2002 may be provided with a communication channel to submit user requests for approvals, user class designations, expense policies, and other required expense related items, as well as submit user data for use in approving transactions through user requests and data interaction 11. Thus, user requests and data interaction 11 may therefore occur prior to submission of a payment request to merchant device 180 for processing by payment resolution network 170 or may also occur at the time of submission of a payment request. Company manager 2004 may also interact with expense management system 140 through approval and pre-authorizations interaction 12 to submit pre-approvals prior to transaction processing of approved expenses that exceed company user 2002's expense policy and may further interact with expense management system to approve already submitted payment requests by company user 2002.

After integration and establishment of interactions 10-12, company user 2002 may then submit a payment request to merchant device 180 during payment request interaction 13, where the payment request may designate an item to purchase using a payment instrument for company 2000 that is managed by expense management system 140. This may occur through in-person or electronic transaction processing using a payment identifier provided to company user 2002 by company 2000. Merchant device may perform transaction submission interaction 14 with payment resolution network 170 in order to provide the payment request to payment resolution network 170 for processing. Payment resolution network 170 may be integrated with expense management system 140 to request transaction authorization through transaction authorization interaction 15. In this regard, network data may be received or detected by expense management system on payment resolution network 170, such as data transfers between an acquiring bank and an issuing bank that communicate to resolve the payment request. Expense management system 140 may be integrated with payment resolution network 170 so that the payment request may only be authorized with the issuing bank based on an analysis of expense policies for company 2000 by expense management system 140.

Expense management system 140 may therefore receive the payment request and may identify user 16a based on the payment instrument identifier, user identifier, or other information in the payment request. Identification of the user may allow for determination of the user's organization and user class within the organization. Thus, expense management system 140 may determine one or more expense policies that are associated with the payment request and may apply the expense policies to verify transaction 16b. This may be done through associations 1008 of user classes 1002 with expense policies 1004 to determine the appropriate expense policy for the payment request. Based on expense policies 1004 and the transaction data for the payment request, expense management system 140 may then approve or deny 16c the payment request, which may be relayed to the issuing bank for execution. Finally, based on the approval or denial at 16c, payment resolution network 170 may perform payments interaction 17 to issue payments with merchant device 180 when approved.

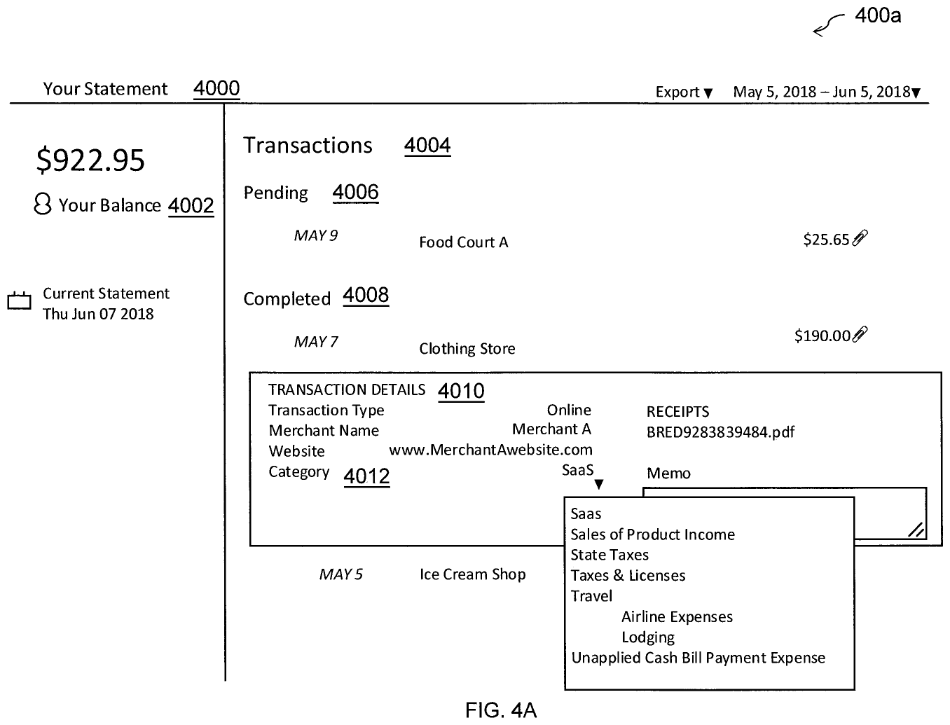

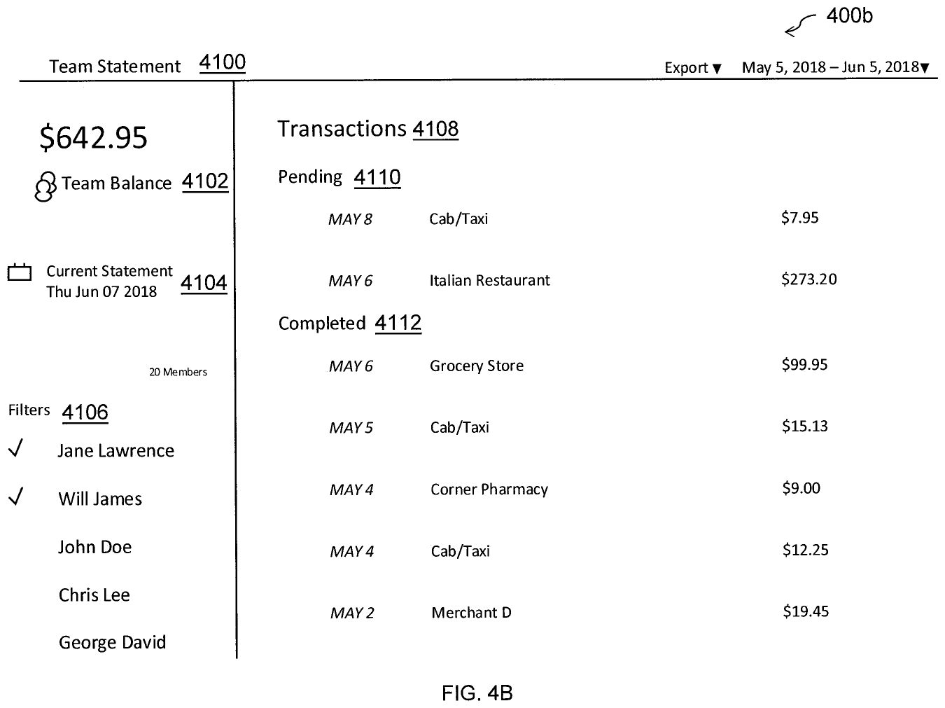

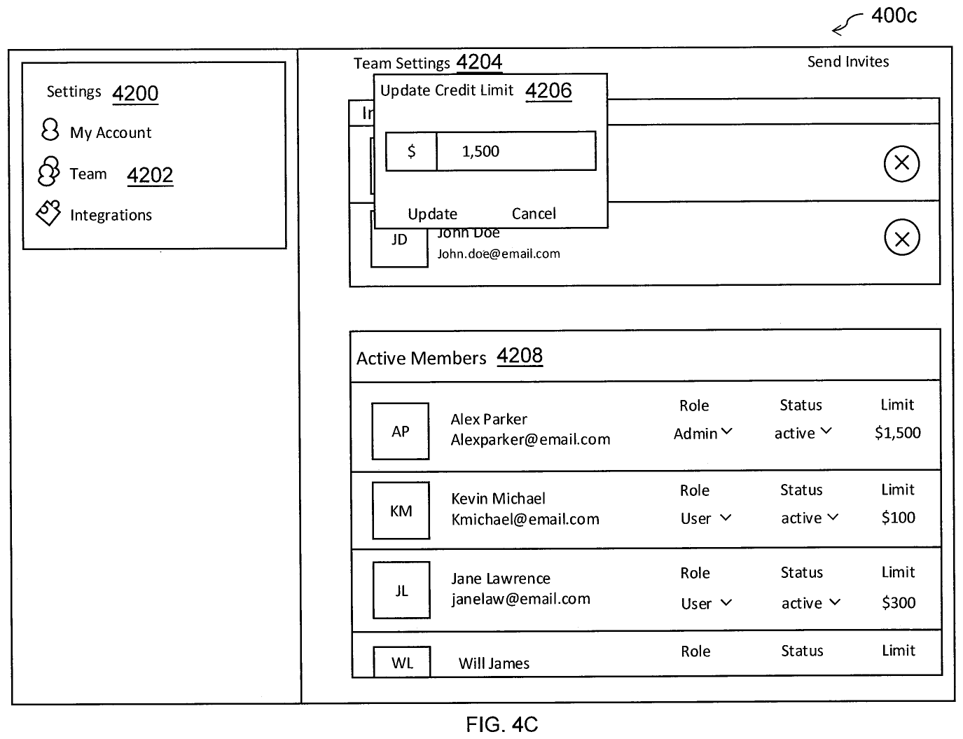

FIG. 4A is an exemplary interface of a dashboard for employee management of expenses based on variable user classes and expense policies, according to an embodiment. Interface 400a of FIG. 4A is displayed by a user device accessing a system, such as expense management system 140 of FIG. 1A.

In this regard, interface 400a includes a personal statement 4000 for a user of an expense management system when that user views their prior transactions expensed to a company based on company expense policies for the user's class. Personal statement 4000 in interface 400a display an individual balance 4002 of charges by the user for expenses, which may also include an amount of a total expense policy used (e.g., $922.95 of $5,000 maximum over an amount of time). This may allow a user to control their spending under the expense policy and make sure that they comply with the expense policy.

Additionally, interface 400a include additional information for personal statement 4000. For example, interface 400a includes transactions 4004 for the user, which includes pending transactions 4004 and complete transactions 4008 processed using the expense management system and approved under an expense policy. Transactions 4004 may include transactions details 4010 for a transaction, which may allow the user to view the transaction detail to make sure the transaction complies with an expense policy. Finally, category 4012 may allow the user to assign the transaction to an accounting category or export to accounting software.

FIG. 4B is an exemplary interface of a dashboard for administrator management of expenses based on variable user classes and expense policies, according to an embodiment. Interface 400b of FIG. 4B is displayed by a user device accessing a system, such as expense management system 140 of FIG. 1A.

Interface 400b includes a team statement 4100, which may be displayed to a manager of a team, accounting personnel, or other administrator when viewing team expenses for one or more user classes (e.g., sales, management, etc.). When the administrator views team statement 4100, the administrator may view pending and completed transaction for a team that have been approved under the expense policy rules for that team. Additionally, team statement 4100 includes a team balance 4102 for a current statement 4104. Team statement 4100 may also allow an administrator to apply filters 4106, such as team members, transaction type, expense type or rule, etc., for team statement 4100 during viewing.

Team statement 4100 allows the administrator to view transaction 4108 in an interface or dashboard for review. Transactions 4108 include pending transactions 4110 and completed transactions 4112. In certain embodiments, pending transactions 4110 may allow the administrator to review and approve transactions that may require approval, or deny transactions that violate an expense rule. Thus, interface 400b may include additional options or functionality that allows interface 400b to act as a dashboard to real-time transaction approvals based on requests by users and/or violations of expense policies.

FIG. 4C is an exemplary interface of a dashboard for establishing and updating variable user classes and expense policies with an expense management service provider, according to an embodiment. Interface 400c of FIG. 4C is displayed by a user device accessing a system, such as expense management system 140 of FIG. 1A.

In interface 400c, an administrator of a team, user class, or company may view an interface or dashboard of a portal that allows for the administrator to set and change policy settings for a user class. For example, settings 4200 allow the administrator to view a team 4202 and set or adjust team settings 4204. In certain embodiments, this may be related to a credit limit 4206 of the team, which may allow the administrator to increase or decrease the allowed credit limit of that team. Additionally, the administrator may view active members 4208 that may allow the administrator to add or remove members from a user class in order to adjust the user class. Additional functionalities may also be implemented in interface 400c based on the administrator's permissions and requirements for expense policy management, such as additional expense policy settings and associations of team 4202 to one or more expense policies.

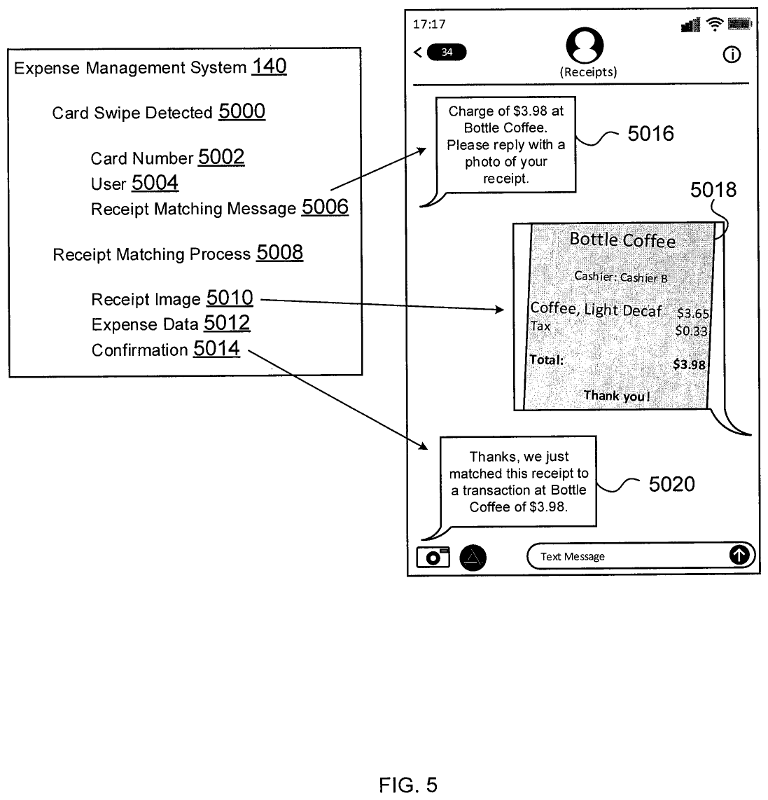

FIG. 5 is an exemplary interaction between an expense management service provider and an employee device for receipt tracking, according to an embodiment. Environment 500 includes expense management system 140 discussed in reference to FIG. 5 that interacts with a user device, such as a mobile phone of a user that is part of an organization or company using expense management system 140 to manage expenses. In this regard, environment 500 shows interactions between expense management system 140 and the user device to perform receipt tracking for accounting and auditing purposes.

In environment 500, expense management system 140 detects a card swipe 5000. This may include data such as a card number 5002 for the card that was swiped, which may be used to identify a user 5004. Once user 5004 is identified, a receipt matching message 5006 may be generated and transmitted to the user device of user 5004. For example, text message 5016 may appear on an interface of the user device that requests that the user capture an image of the receipt associated with detected card swipe 5000. The user may receive text message 5016 right after detection of card swipe 5000 by expense management system 140 because of the integration of expense management system 140 with the payment network that allows for network data to be quickly received from transaction data exchanged on the payment network.

After transmission of text message 5016, expense management system 140 may wait for response, such as image 5018 transmitted back to expense management system 140. After receipting image 5018, expense management system 140 may execute receipt matching process 5008, which may process receipt image 5010 received by expense management system to determine expense data 5012, which may be matched to detected card swipe 5000. If expense data 5012 is matched to detected card swipe 5000, then confirmation 5014 may be generated and may be transmitted back to the user device. Thus, a confirmation message 5020 may be displayed by the user device, which may alert the user that receipt matching was performed and completed by expense management system 140.

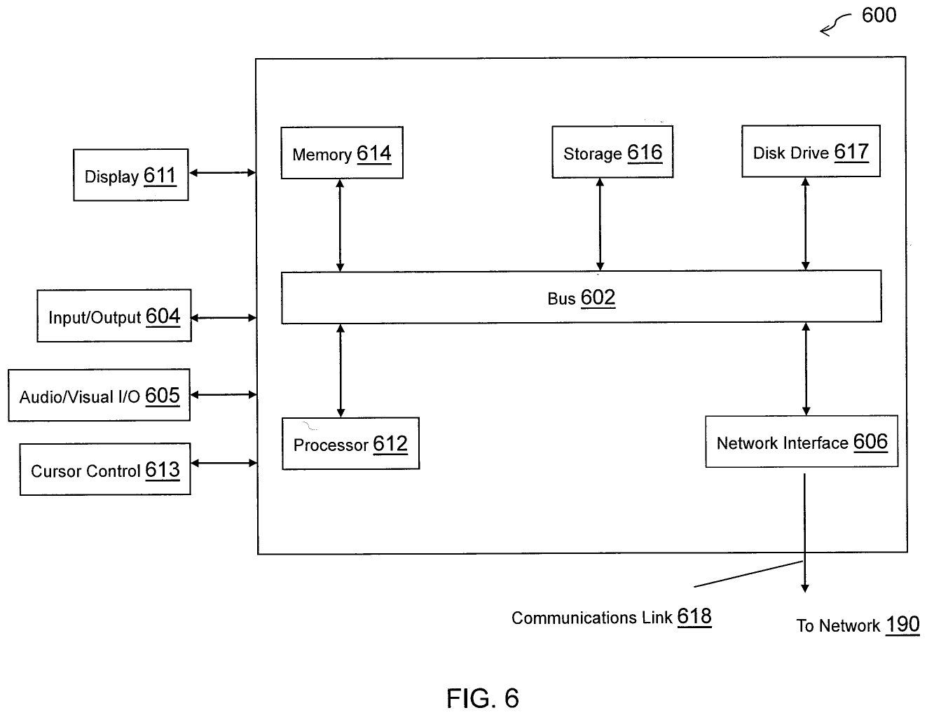

FIG. 6 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, image, or links, and/or moving one or more images, etc., and sends a corresponding signal to bus 602. I/O component 604 may also include an output component, such as a display 611 and a cursor control 613 (such as a keyboard, keypad, mouse, etc.). An optional audio input/output component 605 may also be included to allow a user to use voice for inputting information by converting audio signals. Audio I/O component 605 may allow the user to hear audio. A transceiver or network interface 606 transmits and receives signals between computer system 600 and other devices, such as another communication device, service device, or a service provider server via network 190. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory storing instructions; and
one or more hardware processors coupled to the non-transitory memory and configured to read the instructions from the non-transitory memory to cause the system to perform operations of:
receiving, through a transaction processing platform associated with the system, a payment request from a user to a merchant, wherein the payment request comprises a payment card identifier;
determining an organizational entity associated with the user based on the payment card identifier;
determining a user class for the user with the organizational entity;
determining a policy for the user class with the organization entity, wherein the policy comprises a rule associated with transaction approval by the system;
verifying whether the payment request complies with the policy for the user class; and
determining whether to process the payment request based on the verifying.

2. The system of claim 1, wherein the payment card identifier is specific to one of the user or the user class, and wherein the rule in the policy is specific to the one of the user or the user class.

3. The system of claim 1, wherein the operations further comprise:
determining transaction information associated with the payment request based on a merchant identifier associated with the payment request and the payment card identifier,
wherein the verifying whether the payment request complies with the policy comprises determining whether the transaction information is allowed by the rule.

4. The system of claim 1, wherein the rule is one of a plurality of rules for the policy associated with at least one of allowed merchants, allowed items, and monetary limits, and wherein the verifying whether the payment request complies with the policy comprises determining whether the payment request is allowed by each of the plurality of rules.

5. The system of claim 1, wherein the verifying whether the payment request complies with the policy comprises determining whether the payment request violates the policy, and wherein the operations further comprise:
determining whether there is a pre-approval condition set for one of the user or the payment request,
wherein the determining whether to process the payment request is further based on whether there is the pre-approval condition set for the one of the user or the payment request.

6. The system of claim 1, wherein the verifying whether the payment request complies with the policy comprises determining whether the payment request violates the policy, and wherein the operations further comprise:
determining an authorization entity associated with the organizational entity that provides approvals for payment requests violating the policy; and
transmitting an electronic notification to the authorization entity, wherein the electronic notification comprises an executable process to authorize the payment request through the system,
wherein the determining whether to process the payment request is further based on a response to the electronic notification.

7. The system of claim 6, wherein the payment request is denied from processing based on at least one of an unauthorized payment request response from the authorization entity or no response from the authorization entity after an amount of time.

8. The system of claim 1, wherein the rule comprises a spending limit for the user within a time period, wherein the spending limit comprises a first lower limit for allowed amounts, and a second higher limit for the allowed amounts that cause an alert to be generated by the system in response to a purchase exceeding the first lower limit but not the second higher limit, and wherein the operations further comprise:
determining whether to generate the alert based on the payment request and the spending limit.

9. The system of claim 8, wherein the spending limit is further for accrued purchases during the time period, and wherein the alert is generated if the payment request causes the accrued purchases to exceed the first lower limit, and wherein the payment request is denied if the payment request causes the accrued purchases to exceed the second higher limit.

10. The system of claim 9, wherein the payment request is from a plurality of users including the user, wherein the verifying whether the payment request complies with the policy comprises determining whether the payment request violates the policy, and wherein the operations further comprise:
determining whether the payment request complies with at least one of an additional policy for one of the plurality of users or a combination of policies for the plurality of users,
wherein the determining whether to process the payment request is further based on the determining whether the payment request complies with the at least one of the additional policy or the combination of policies.

11. The system of claim 1, wherein prior to the verifying, the operations further comprise:
receiving transaction data provided with the payment request; and
matching the payment request to the merchant and an item provided by the merchant using the transaction data,
wherein the verifying is further based on the matching.

12. The system of claim 1, wherein the user class comprises one of a plurality of user classes established by the system for a business entity associated with the user, wherein each of the plurality of user classes as set by the business entity for employee classifications by the business entity based on at least on of first manual input for the employee classifications or first automated configuration provided by the system for the employee classifications.

13. The system of claim 12, wherein the policy comprises one of a plurality of policies established by the system for the business entity, wherein each of the plurality of policies are associated with at least one of the plurality of user classes, and wherein the plurality of policies are generated using at least one of second manual input of rules associated with the plurality of policies, default policy selection for the rules, or second automated configuration of the rules.

14. The system of claim 1, wherein the operations further comprise:
integrating with an organizational computing system of the organizational entity, wherein the organization computing system provides employee data for the organizational entity; and
providing real-time changes to at least one of the user, the user class, and the policy based on the employee data from the organizational computing system.

15. The system of claim 1, wherein the operations further comprise:
processing the payment request with the merchant;
receiving a merchant transaction history associated with the payment request from a merchant device for the merchant;
transmitting an electronic message to a user device associated with the user, wherein the electronic message comprises a request for a receipt associated with the payment request;
receiving an electronic response from the user device, wherein the electronic response comprises an image; and
determining whether the image corresponds to the payment request based on the merchant transaction history.

16. A method comprising:
receiving a pre-approval condition for one of a user or a user class with a company, wherein the pre-approval condition allows processing of a transaction that is barred by a policy set for the one of the user or the user class;
receiving, through a transaction processing platform associated with a cardholder management system, transaction data for a transaction between a merchant and a user, wherein the transaction data comprises an identifier for a payment instrument managed by the cardholder management system;
determining a company associated with the identifier, wherein the cardholder management system manages expense policies associated with the payment instrument for the company;
determining a user class for the user based on the identifier and the company;
determining an expense policy for the user based on the user class and the company, wherein the expense policy comprises a transaction permission for transactions approved for the user class;
determining that the transaction is unapproved by the policy; and
determining whether the transaction is approved by the pre-approval condition.

17. The method of claim 16, further comprising:
in response to determining that the transaction is unapproved by the pre-approval condition, requesting an approval from an expense manager associated with the company.

18. The method of claim 17, wherein the requesting the approval comprises one of publishing on a communication network associated with the company, messaging to at least one contact of the user associated with the company or connecting with the expense manager at a time designated by the expense manager for expense approvals.

19. A non-transitory machine-readable medium having stored thereon machine-readable instructions executable to cause a machine to perform operations comprising:
receiving, through a transaction processing platform associated with a cardholder management system, a card identifier with a transaction between a merchant and a user;
determining an organization providing the card identifier to an employee for transactions associated with the organization;
determining an expense policy for the user at the organization, wherein the expense policy comprises a rule set for the transactions allowed by the organization for the employee;
determining that the transaction exceeds the rule set for the expense policy; and
transmitting an approval request to an organization manager associated with the organization.

20. The non-transitory machine-readable medium of claim 19, wherein the transmitting the approval request comprises one of posting the approval request to a network accessible by the organization manager or transmitting a notification comprising the approval request to a device associated with the organization manager.
